(19) United States
(12) Patent Application Publication
(10) Pub. No.: US 2010/0269052 A1
(43) Pub. Date: Oct. 21, 2010

(54) NOTIFYING OF AN UNSCHEDULED SYSTEM INTERRUPTION REQUIRING MANUAL INTERVENTION AND ADJUSTING INTERRUPTION SPECIFICS REACTIVE TO USER FEEDBACK

(75) Inventor: STEFFEN UHLIG, BONDORF (DE)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/425,144

(22) Filed: Apr. 16, 2009

(51) Int. Cl. G06F 3/01

(52) U.S. Cl. 715/752; 719/328

(57) ABSTRACT

A service interruption event for a functional element of a computing system that requires manual intervention on behalf of a human agent can be identified. The manual intervention can result in the functional element being temporarily disabled. A set of subscribers, having previously requested notifications, can be determined as being potentially affected by the unscheduled service interruption event. An interactive electronic message can be conveyed via a notification system to each subscriber of the set. Responses received from the notification system to a portion of the interactive electronic messages can be compiled into a summary. The responses can indicate whether an associated subscriber agrees to the manual intervention occurring at a near future time. The compiled summary can be presented to the human agent. The human agent can then adjust the specifics of the unscheduled service interruption event requiring manual intervention based on the received responses.

### BACKGROUND

The present invention relates to the field of computer systems management, and, more particularly, to the notifying of an unscheduled system interruption requiring manual intervention and adjusting the interruption specifics reactive to user feedback.

Information technology (IT) personnel are tasked with supporting the various computing systems used within an organization. Frequently, support of a computing system requires interrupting one or more of the functions or services provided by the computing system. Typically, an organization employs processes and/or mechanisms by which such service interruptions are minimized, particularly when the computing system being interrupted is of high business importance to the organization. For example, service interruptions to an electronic commerce system are scheduled for non-peak hours or the system includes redundant functional elements, such as redundant servers, that allow for the service to be provided by an alternate element.

However, such measures are generally employed in only a production environment or for computing systems that are deemed to be of organizational importance. Thus, users of non-production computing systems, such as internal development systems, are often caught unaware when IT personnel perform tasks that result in an unscheduled interruption of service. Such unscheduled service interruptions leave users frustrated due to their inability to continue their work and/or a loss of work (i.e., a server is shutdown before a before a process has finished).

Due to the size and complexity of many computing systems, the IT personnel often do not know which users and/or services depend on the service and/or computing system being interrupted. Even having the user information available, IT personnel would be required to manually contact each user as well as determine which other computing systems and/or functional elements are affected by the service interruption.

### BRIEF SUMMARY

The present invention can be implemented in accordance with numerous aspects consistent with the materials presented herein. One aspect of the present invention can include a method for adjusting unscheduled service interruptions based upon subscriber feedback. In such a method, a service interruption event for a functional element of a computing system that requires manual intervention on behalf of a human agent can be identified. The manual intervention can result in the functional element of the computing system being at least temporarily disabled. A set of subscribers, who previously requested notifications, can be determined as having the potential to be affected by the unscheduled service interruption event. An interactive electronic message can be conveyed via a notification system to each subscriber of the set. Responses received from the notification system to at least a portion of the conveyed interactive electronic messages can be compiled into a summary. The responses can indicate whether an associated subscriber agrees to the manual intervention occurring at a near future time. The compiled summary can be presented to the human agent. The human agent can then adjust the specifics of the unscheduled service interruption event requiring manual intervention based on the received responses.

Another aspect of the present invention can include a system for adjusting unscheduled service interruptions based upon subscriber feedback. Such a system can include service providers, a notification system, and a service interruption agent. The service providers can be configured to provide computing services to subscribers. The service providers and computing services can be functional elements of a computing system. The notification system can be configured to convey interactive electronic messages between the computing system and the subscribers. The service interruption agent can be configured to utilize the notification system to solicit feedback messages for an unscheduled service interruption event that affects the computing system and requires intervention on behalf of a human agent from a subset of subscribers determined as being potentially affected by the unscheduled service interruption event. The feedback messages can include an agreement to the unscheduled service interruption event and an objection to the unscheduled service interruption event.

Still another aspect of the present invention can include a computer program product for adjusting unscheduled service interruptions based upon subscriber feedback that includes a computer readable storage medium having embedded computer usable program code. The computer usable program code can be configured to process defective electronic business transactions received from an automated processing system. Processing of the defective electronic business transactions can include calculating a correction value for the defective electronic business transaction. Another portion of the computer usable program code can be configured to determine and execute correction procedures to correct the defective electronic business transaction, based upon the calculated correction value.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for notifying users of unscheduled service interruption events and adjusting interruption specifics in accordance with embodiments of the inventive arrangements disclosed herein.

FIG. 2 is an illustration of an example user-defined dependency model for use with a service interruption agent in accordance with an embodiment of the inventive arrangements disclosed herein.

FIG. 3 is a collection of user interface windows for presenting interactive electronic messages in accordance with an embodiment of the inventive arrangements disclosed herein.

FIG. 4 is a flow chart of a method describing the solicitation of service interruption feedback for an unscheduled service interruption event in accordance with an embodiment of the inventive arrangements disclosed herein.

### DETAILED DESCRIPTION

The present invention discloses a solution that can notify users of an unscheduled service interruption associated with a computing system and can allow the specifics of the unscheduled service interruption to be adjusted based on feedback to the notification. A service interruption agent, operating from within the computing system, can detect the occurrence of an unscheduled service interruption event for a component of the computing. The service interruption agent can then determine the users who have the potential to be affected by the service interruption event. An interactive electronic message can be sent via a notification system to the potentially affected users, who can provide feedback regarding their agreement with the unscheduled service interruption. The feedback can be compiled by the service interruption agent into a summary presented to the user initiating the unscheduled service interruption event.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer usable storage medium having computer usable program code embodied in the medium. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. Examples of a computer readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer usable or computer readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

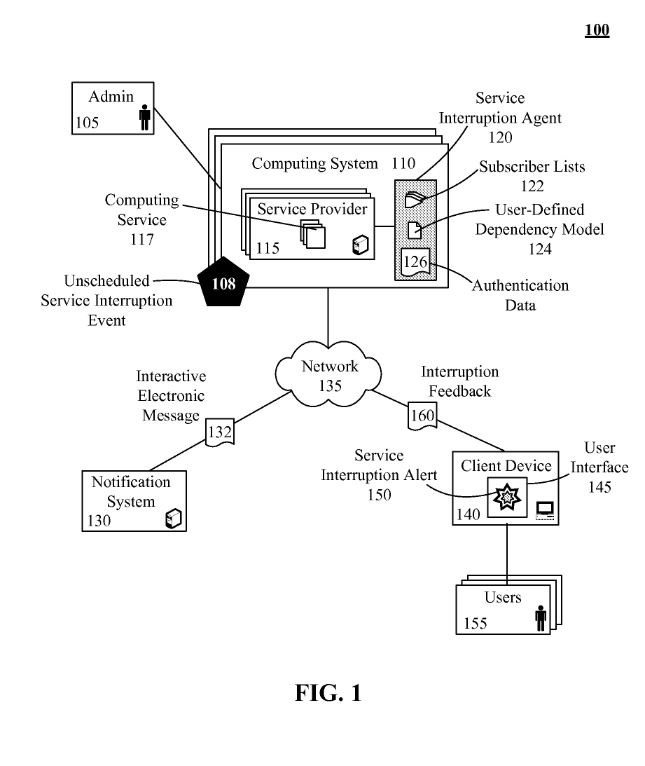

FIG. 1 is a schematic diagram illustrating a system 100 for notifying users of unscheduled service interruption events 108 and adjusting interruption specifics in accordance with embodiments of the inventive arrangements disclosed herein. In system 100, a service interruption agent 120 can notify users 155 of an unscheduled service interruption event 108 for a computing system 110 over the network 135 using a notification system 130. In one embodiment, the computing system 110 can be a non-production computing system. It should be appreciated that manual interventions by an administrator 105 resulting in a computing system 110 interruption are more common in non-production systems than in production ones and traditionally have occurred without considering active workloads of affected users 155.

As used herein, an unscheduled service interruption event 108 refers to an action initiated by either a human user 105, a hardware element (not shown) of the computing system 110, and/or a software element (not shown) of the computing system 110 that prohibits the computing system 110 from providing one or more computing services 117 at a time that is not expected by the users 155. Examples of an unscheduled service interruption event 108 can include, but are not limited to, the need to restart a computing service 117 and/or a service provider 115, the need to shutdown a computing service 117 and/or service provider 115, the need to shutdown the entire computing system 110, and the like.

The computing system 110 can be configured to provide computing services 117 to a variety of users 155. As used herein, the computing system 110, herein referred to as the computing system, represents a computing system that does not operate within a production environment and/or does not have established mechanisms and/or processes for capturing and/or handling unscheduled service interruption events 108. The servers and/or software applications necessary to implement a software development environment can be a generic example of such a computing system 110.

The computing system 110 can include one or more service providers 115 and a service interruption agent 120. The service provider 115 can be an abstract representation of the hardware and/or software components necessary for the computing system 110 to provide a computing service 117. For example, a Web server consisting of a computer configured to act as a server and the software necessary for hosting Web pages can be a representation of a service provider 115.

Since a service provider 115 is an abstract representation, it should be noted that the service providers 115 of the computing system 110 can include a multitude of components arranged in a variety of configurations. The specifics of the components and the configurations are not of particular relevance to the embodiment of the present invention.

The service interruption agent 120 can represent a software component of the computing system 110 configured to send interactive electronic messages 132 to solicit interruption feedback 160 from users 155 when an unscheduled service interruption event 108 occurs. A notification system 130 can be used by the service interruption agent 120 as the means to send interactive electronic messages 132 to the users 155 and receive interruption feedback 160 from the users 155. The notification system 130 can represent the hardware and/or software required to send/receive interactive electronic messages 132 and interruption feedback 160, such as an instant messaging server and an instant messaging client.

In one contemplated embodiment, the notification system 130 can be implemented utilizing middleware, such as the MESSAGE BROKER of the WEBSPHERE APPLICATION SERVER. In another embodiment, the notification system 130 can be a standalone messaging system, such as LOTUS SAMETIME.

The service interruption agent 120 can selectively solicit users 155 based upon a user-defined dependency model 124 of the computing system 110 and subscriber lists 122 to which the users 155 have previously subscribed. For example, a user 155 developing Web applets can subscribe to receive service interruption alerts 150 and provide interruption feedback 160 for unscheduled service interruption events 108 affecting a specific Web server 115.

The user-defined dependency model 124 can be an abstract representation of the computing system 110 that can define the dependencies that exist between the various components of the computing system 110. The service interruption agent 120 can use the user-defined dependency model 124 to determine ancillary elements of the computing system 110 that can be affected by the unscheduled service interruption event 108. For example, operation of an ecommerce server can be affected by an interruption in service of a Web server.

The subscriber lists 122 can store the data that defines which components of the computing system 110 for which a user 155 requests to receive service interruption alerts 150. It should be noted that the components of the computing system 110 for which a user 155 subscribes should be identifiable by the service interruption agent 120, such as corresponding to the terminology used within the user-defined dependency model 124. Additionally, it should be emphasized that the use of the subscriber lists 122 alleviates the burden of knowledge capture and management from the administrators 105 servicing the computing system 110.

The service interruption agent 120 can also include authentication data 126 to provide secure communication with the notification system 130. The authentication data 126 can store the pertinent data needed to identify/authenticate the service interruption agent 120 with the notification system 130 to reduce the possibility of generating erroneous or false service interruption alerts 150.

The interactive electronic messages 132 sent via the notification system 130 by the service interruption agent 120 can be viewed as a service interruption alert 150 by a user 155 within the user interface 145 of a client device 140. The client device 140 can represent any computing device capable of communicating with the notification system 130 over the network 135 and supporting the user interface 145.

The user interface 145 can represent the means for visually presenting the service interruption alert 150 to the user 155. The user interface 145 can be an existing component of the client device 140, such as an instant messaging client application, or utilize the existing capabilities of the client device 140, such as operating system alert functions. The service interruption alert 150 can inform the user 155 of the impending unscheduled service interruption event 108 and allow the user 155 to provide interruption feedback 160.

The user 155 can utilize the user interface 145 to send interruption feedback 160 in response to the service interruption alert 150. The interruption feedback 160 can represent the user's 155 agreement or objection to the unscheduled service interruption event 108. The interruption feedback 160 can include additional user-entered data, such as an alternate time for performing the unscheduled service interruption event 108.

The notification system 130 can convey the interruption feedback 160 to the service interruption agent 120. The received interruption feedback 160 can then be presented to an administrator 105 of the computing system 110. The interruption feedback 160 presented can be synthesized into a summary format and can include the determination of a time to which the unscheduled service interruption event 108 should be postponed in order to accommodate objections by the users 155.

For example, the service interruption agent 120 can determine that the unscheduled service interruption event 108 should be deferred from 11:00 am to 2:00 pm in order to satisfy one objection requesting an additional hour and another objection requesting an additional two and a half hours.

Network 135 can include any hardware/software/and firmware necessary to convey data encoded within carrier waves. Data can be contained within analog or digital signals and conveyed though data or voice channels. Network 135 can include local components and data pathways necessary for communications to be exchanged among computing device components and between integrated device components and peripheral devices. Network 135 can also include network equipment, such as routers, data lines, hubs, and intermediary servers which together form a data network, such as the Internet. Network 135 can also include circuit-based communication components and mobile communication components, such as telephony switches, modems, cellular communication towers, and the like. Network 135 can include line based and/or wireless communication pathways.

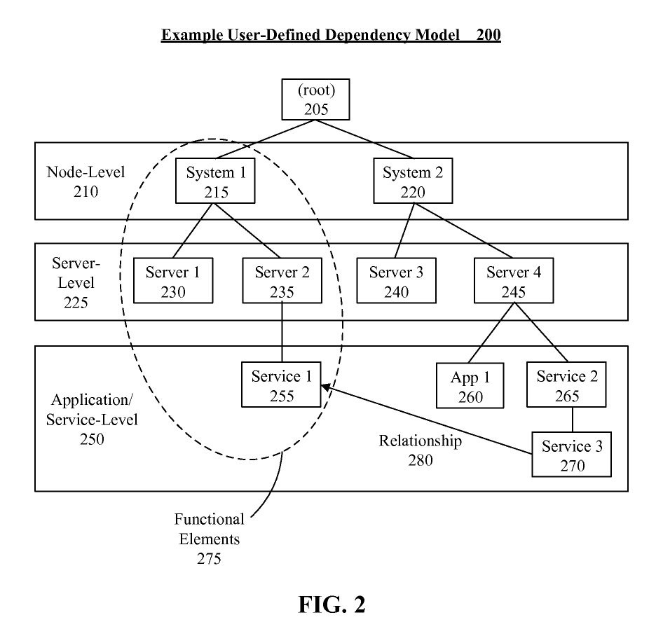

FIG. 2 is an illustration of an example user-defined dependency model 200 for use with a service interruption agent in accordance with an embodiment of the inventive arrangements disclosed herein. The example user-defined dependency model 200 can be utilized within the context of system 100 or any other system that utilizes a service interruption agent to solicit feedback from users about unscheduled service interruption events using interactive electronic messages. It should be noted that the contents of the example user-defined dependency model 200 are for illustrative purposes only and are not meant as an exact implementation.

A user-defined dependency model 200 can consist of an origin or (root) 205 and one or more related functional elements 275. A functional element 275 can represent a logical grouping of other functional elements 275, such as a system 215 or 220, or can represent an individual logical component, such as a server 230, 235, 240, or 245.

Functional elements 275 can be directly associated with each other by relationships 280. A relationship 280 can include the directionality of affect. As shown in this example 200, Service_1 255 can be affected by Service_3 270, as indicated by the arrow of their relationship 280, but not vice versa. Thus, an interruption of Service_1 255 can have no effect upon Service_3 270, but an interruption of Service_3 270 can cause an interruption in Service_1 255.

Hierarchical dependencies between functional elements 275 can be expressed level 210, 225, or 250 of the functional elements 275. As shown in this example user-defined dependency model 200, the functional elements 275 at the application/service level 250 can directly depend upon functional elements 275 that exist at either the server-level 225 or application/service level 250. Functional elements 275 at the server-level 225 can directly depend upon functional elements 275 at the application/service level 250, server-level 225, or node-level 210. Functional elements 275 at the node-level 210 can directly depend upon other functional elements 275 at the node-level 210 or server-level 225.

This granular approach to organizing functional elements 275 can allow for users to subscribe for service interruption alerts at the level 210, 225, and 250 appropriate for their usage. For example, a user only concerned with the functioning of App_1 260 can subscribe for service interruption alerts that affect only App_1 260. However, a user who utilizes App_1 260 and Service_2 265 can subscribe to receive service interruption alerts for Server_4 245, since both App_1 260 and Service_2 265 are both dependent upon Server_4 245.

It should be emphasized that this level of granularity in respect to receiving notifications is not currently available in conventional service interruption notification systems.

The use of the contents of the user-defined dependency model 200 by a service interruption agent can be illustrated best by an example scenario where a service interruption event is detected for Service_2 265. The service interruption agent can notify all users subscribed to Service_2 265. Additionally, the service interruption agent can notify users who are subscribed to functional elements 275 dependent upon Service_2 265, such as those users subscribed to Service_3 270 and Server_4 245.

Since Service_1 255 is dependent upon Service_3 270, the subscribers of Service_1 255 can also be notified. The subscribers of Server_2 235 can also be notified since Service_1 255 is affected by the service interruption event.

The depth of dependency levels 210, 225, and 250 utilized by the service interruption agent to determine affected functional elements 275 can be dependent upon the implementation of the service interruption agent as well as the quantity of levels contained within the user-defined dependency model 200.

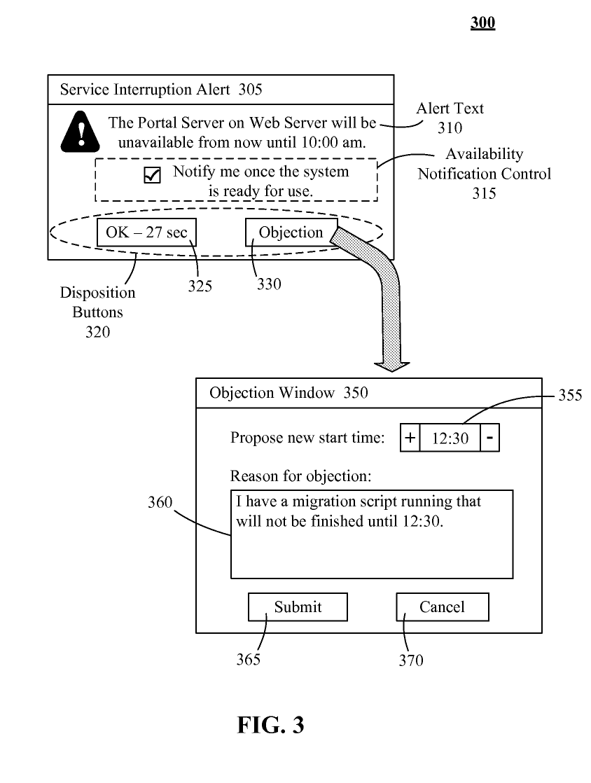

FIG. 3 is a collection 300 of user interface windows 305 and 350 for presenting interactive electronic messages in accordance with an embodiment of the inventive arrangements disclosed herein. The user interface windows 305 and 350 of collection 300 can be utilized within the context of system 100 or any other system that utilizes a service interruption agent to solicit feedback from users about unscheduled service interruption events using interactive electronic messages.

User interface window 305 can present the data of an interactive electronic message sent from the service interruption agent to a user as a service interruption alert. The service interruption alert window 305 can include alert text 310, an availability notification control 315, and disposition buttons 320.

The user can be presented with the alert text 310 that describes the nature of the unscheduled service interruption event. The alert text 310 can be directly entered by an administrator initiating the unscheduled service interruption event and/or generated by the service interruption agent from a preset template.

The availability notification control 315 can correspond to a user-configurable mechanism of the service interruption alert window 305 that can allow the user to request notification once the server or service is made available. As shown in this example, the availability notification control 315 consists of a user-selectable checkbox with text explaining its purpose.

The disposition buttons 320 can represent the mechanism by which a user can express their agreement to or objection of the unscheduled service interruption event. A user in agreement with the performance of the unscheduled service interruption event can select the OK button 325. As shown in this example, the OK button 325 can also display a countdown timer whose lapse without interaction on the part of the use will result in an automatic agreement to the unscheduled service interruption event.

It should be noted that use of a countdown timer within the OK button 325 must be supported by the service interruption agent as well as the client device and/or user interface presenting the service interruption alert window 305.

A user not in agreement with the performance of the unscheduled service interruption event can select the objection button 330, which can result in the display of the objection window 350. The objection window 350 can provide the user with the ability to inform the administrator who has initiated the unscheduled service interruption event of their opposition.

The objection window 350 can include structured controls 355 and 360 to collect data regarding the user's objection, a submit button 365, and a cancel button 370. In this example, the objection window 350 contains a control 355 for proposing a different time to perform the unscheduled service interruption event and a text area 360 where the user can enter their justification or reason for their objection.

The use of structured controls 355 and 360 can ensure consistent data formats for these data fields when sent to the service interruption agent. This can allow the service interruption agent to perform various calculations and/or manipulations of the data received from the objection window 350, such as the determination of a time that satisfies the proposed times 355 from all objections received.

Selection of the submit button 365 can send the data input into the objection window 350 to the service interruption agent as interaction feedback. The cancel button 370 can abort the submission of the objection.

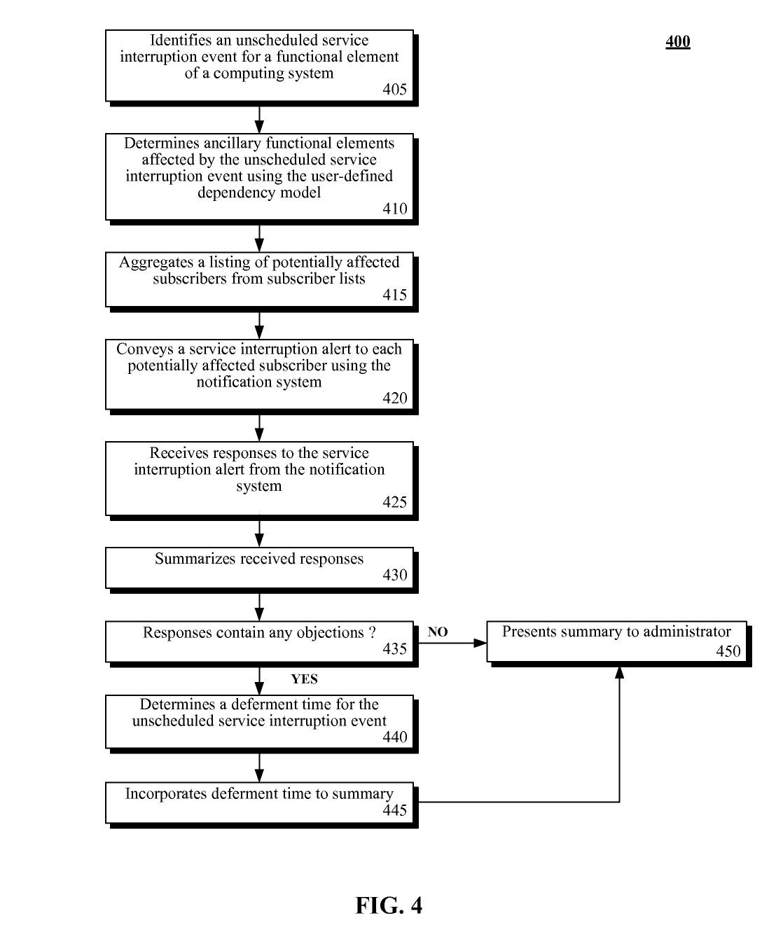

FIG. 4 is a flow chart of a method 400 describing the solicitation of service interruption feedback for an unscheduled service interruption event in accordance with an embodiment of the inventive arrangements disclosed herein. Method 400 can be performed in the context of system 100, and/or utilizing the user-defined dependency model of FIG. 2.

Method 400 can begin with step 405 where an unscheduled service interruption event can be identified for a functional element of a computing system by a service interruption agent. Ancillary functional elements affected by the unscheduled service interruption event can be determined using the user-defined dependency model in step 410. In step 415, a listing of potentially affected subscribers can be aggregated from the subscriber lists.

A service interruption alert can be conveyed to each potentially affected subscriber via the notification system in step 420. In step 425, responses to the service interruption alert can be received from the notification system. The received responses can be summarized in step 430.

In step 435 it can be determined if the received responses contained any objections. When objections to the unscheduled service interruption event exist, step 440 can execute where the service interruption agent can determine a deferment time for the unscheduled service interruption event. The deferment time can be incorporated into the summary in step 445.

Upon completion of step 445 or when the received response do not contain any objections, step 450 can execute where the summary can be presented to an administrator or other designated human agent.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for adjusting unscheduled service interruptions based upon subscriber feedback comprising:
identifying an unscheduled service interruption event for a functional element of a computing system requiring manual intervention on behalf of a human agent, wherein the manual intervention results in the functional element of the computing system being at least temporarily disabled;
determining a set of at least one subscriber potentially affected by the unscheduled service interruption event, wherein the at least one subscriber has previously requested to be notified of unscheduled service interruption events;
for each determined subscriber of the set, conveying an interactive electronic message via a notification system to each subscriber;
compiling responses received from the notification system to at least a portion of the conveyed interactive electronic messages into a summary, wherein the responses indicate whether an associated subscriber agrees to the manual intervention occurring at a near future time; and
presenting the compiled summary to the human agent, wherein the human agent is able to adjust specifics of the service interruption event requiring manual intervention based on the received responses.

2. The method of claim 1, wherein the subscribers are subscribers of a computing service provided by the computing system affected by the unscheduled service interruption event.

3. The method of claim 2, wherein the computing system providing the computing service is abstracted from hardware upon which the computing system runs.

4. The method of claim 1, wherein the computing system and the notification system operate within a service-oriented architecture (SOA) environment, wherein the notification system is implemented within middleware.

5. The method of claim 4, wherein the notification system comprises an application programming interface (API) that provides reliable, asynchronous communication between software applications, wherein the API is an API of the middleware.

6. The method of claim 1, wherein the notification system is a communications server functionally independent of the computing system associated with the unscheduled service interruption event.

7. The method of claim 1, wherein the identification of the unscheduled service interruption event, the determination of the set of at least one potentially affected subscriber, the conveyance of the interactive electronic messages, the compiling of the received responses, and the presentation of the compiled summary are automatically executed by a service interruption agent in response to an action performed by the human agent, wherein the service interruption agent operates from within the computing system associated with the unscheduled service interruption event.

8. The method of claim 1, wherein the determining of the set of potentially affected subscribers further comprises:
identifying the functional element within a user-defined dependency model of the computing system, wherein the user-defined dependency model outlines hierarchical relationships between functional elements of the computing system;
analyzing the hierarchical relationships associated with the identified functional element to determine ancillary functional elements affected by the unscheduled service interruption event of the identified functional element;
when ancillary functional elements exist for the identified functional element, adding the subscribers of each ancillary functional element to the set of potentially affected subscribers; and
repeating the analysis of hierarchical relationships for each ancillary functional element, wherein said analysis excludes the identified functional element and the ancillary functional elements of the identified functional element.

9. The method of claim 8, wherein the ancillary functional elements of the identified functional element comprise at least one functional element from a secondary computing system.

10. The method of claim 1, wherein the compiling of the received responses further comprises:
grouping the received responses by response type, wherein the response type comprises at least one of an agreement to the unscheduled service interruption event and an objection to the unscheduled service interruption event;
determining a deferment time for the unscheduled service interruption event from the group of received responses containing objections, wherein the deferment time resolves the objections; and
incorporating the deferment time into the summary.

11. The method of claim 1, wherein the functional element comprises at least one of a computing service, a service provider, a physical computing device, a resource of a physical computing device, a software application, and a network device.

12. The method of claim 1, wherein the at least one potentially affected subscriber is at least one of a human agent, a computing service, a software application, another functional element, and a physical computing device.

13. A system for adjusting unscheduled service interruptions based upon subscriber feedback comprising:
a plurality of service providers configured to provide at least one computing service to a plurality of subscribers, wherein each service provider and each computing service are functional elements of a computing system;
a notification system configured to convey interactive electronic messages between the computing system and the plurality of subscribers; and
a service interruption agent configured to utilize the notification system to solicit feedback messages for an unscheduled service interruption event that affects the computing system and requires intervention on behalf of a human agent from a subset of the plurality of subscribers determined as being potentially affected by the unscheduled service interruption event, wherein said feedback messages comprise at least one of an agreement to the unscheduled service interruption event and an objection to the unscheduled service interruption event.

14. The system of claim 13, wherein the service interruption agent further comprises:
a user-defined dependency model defining hierarchical relationships between functional elements of the computing system;
a plurality of subscriber lists configured to record subscriptions for the plurality of subscribers to receive service interruption alerts for a functional element of the computing system; and
a plurality of authentication data configured to store authentication data values for securing communications between the service interruption agent and the notification system.

15. The system of claim 13, wherein the service interruption agent presents the human agent with a summary of the feedback messages received from the subset of the plurality of subscribers.

16. The system of claim 15, wherein the summary comprises a deferment time for the unscheduled service interruption event, wherein said deferment time is determined by the service interruption agent from the feedback messages objecting to the unscheduled service interruption event.

17. The system of claim 13, wherein the plurality of service providers, the notification system, and the service interruption agent operate within a service-oriented architecture (SOA) environment, wherein the notification system is implemented within middleware.

18. A computer program product for adjusting service interruptions based upon subscriber feedback comprising a computer readable storage medium having computer usable program code embodied therewith, the computer usable program code comprising:
computer usable program code configured to identify an unscheduled service interruption event for a functional element of a computing system requiring manual intervention on behalf of a human agent, wherein the manual intervention results in the functional element of the computing system being at least temporarily disabled;
computer usable program code configured to determine a set of at least one subscriber potentially affected by the unscheduled service interruption event, wherein the at least one subscriber has previously requested to be notified of unscheduled service interruption events;
computer usable program code configured to, for each determined subscriber of the set, convey an interactive electronic message via a notification system to each subscriber;
computer usable program code configured to compile responses received from the notification system to at least a portion of the conveyed interactive electronic messages into a summary, wherein the responses indicate whether an associated subscriber agrees to the manual intervention occurring at a near future time; and
computer usable program code configured to present the compiled summary to the human agent, wherein the human agent is able to adjust specifics of the unscheduled service interruption event requiring manual intervention based on the received responses.

19. The computer program product of claim 18, wherein the determining of the set of potentially affected subscribers further comprises:
computer usable program code configured to identify the functional element within a user-defined dependency model of the computing system, wherein the user-defined dependency model outlines hierarchical relationships between functional elements of the computing system;
computer usable program code configured to analyze the hierarchical relationships associated with the identified functional element to determine ancillary functional elements affected by the service interruption event of the identified functional element;
computer usable program code configured to, when ancillary functional elements exist for the identified functional element, add the subscribers of each ancillary functional element to the set of potentially affected subscribers; and
computer usable program code configured to repeat the analysis of hierarchical relationships for each ancillary functional element, wherein said analysis excludes the identified functional element and the ancillary functional elements of the identified functional element.

20. The computer program product of claim 18, wherein the compiling of the received responses further comprises:
computer usable program code configured to group the received responses by response type, wherein the response type comprises at least one of an agreement to the unscheduled service interruption event and an objection to the unscheduled service interruption event;
computer usable program code configured to determine a deferment time for the unscheduled service interruption event from the group of received responses containing objections, wherein the deferment time resolves the objections; and
computer usable program code configured to incorporate the deferment time into the summary.
